(19) United States
(12) Patent Application Publication
(10) Pub. No.: US 2024/0332681 A1
(43) Pub. Date: Oct. 3, 2024

(54) EXTERIOR BODY

(71) Applicant: HONDA MOTOR CO., LTD., Tokyo (JP)

(72) Inventor: Hidemasa USUI, Saitama (JP)

(21) Appl. No.: 18/585,069

(22) Filed: Feb. 23, 2024

(30) Foreign Application Priority Data
Mar. 31, 2023 (CN) 202310336564.1

(51) Int. Cl. H01M 50/141; H01M 50/129; H01M 50/131; H01M 50/186; H01M 50/204

(52) U.S. Cl. CPC H01M 50/141; H01M 50/129; H01M 50/131; H01M 50/186; H01M 50/204

(57) ABSTRACT

To provide an exterior body capable of improving energy density of a battery cell, suppressing permeation of moisture into the interior of the battery cell, and achieving high thermal conductivity. An exterior body for housing an electrode laminate. The exterior body includes a metal layer, an inner resin layer disposed on an inner side of the metal layer, and an outer resin layer disposed on an outer side of the metal layer. The inner resin layer includes a first layer including a cycloolefin polymer. The inner resin layer includes a facing part facing the electrode laminate in a laminating direction and a non-facing part not facing the electrode laminate. The facing part includes a region having a thickness in the laminating direction that is smaller than that of the non-facing part.

This application is based on and claims the benefit of priority from Chinese Patent Application No. 202310336564.1, filed on 31 Mar. 2023, the content of which is incorporated herein by reference.

### BACKGROUND OF THE INVENTION

### Field of the Invention

The present invention relates to an exterior body.

### Related Art

In recent years, research and development have been conducted on secondary batteries that contribute to energy efficiency in order to ensure that more people have access to affordable, reliable, sustainable, and advanced energy.

The secondary battery has a structure in which a solid electrolyte or an electrolytic solution is provided between a positive electrode and a negative electrode. As an aspect of a secondary battery, there is known an aspect in which an electrode laminate including a plurality of the above electrodes that are laminated is housed in an exterior body such as a laminate film and can be used in this state. As a configuration of the exterior body, there is known a configuration including a metal layer and a resin layer (for example, see Patent Document 1).
Patent Document 1: Japanese Unexamined Patent Application, Publication No. 2019-139844

### SUMMARY OF THE INVENTION

The laminate case, which is an exterior body disclosed in Patent Document 1, includes a metal layer, and a first resin layer and a second resin layer that overlap with the metal layer from the inside of the laminate case. According to the above technique, even when the first resin layer melts, the second resin layer suppresses an internal short circuit.

Various functions are required for the exterior body in addition to the suppression of short circuits. For example, it is required to increase the energy density of the battery cell by reducing the thickness of the exterior body. However, when the thickness of the exterior body is simply reduced, permeation of moisture into the interior of the battery cell cannot be suppressed. Furthermore, to improve the heat dissipation of the battery cell, it is required to increase the thermal conductivity of the exterior body itself. However, to achieve high thermal conductivity, the thickness of the metal layer must be increased, which is in conflict with the above requirement for higher energy density. Therefore, there has been a need for a technique relating to an exterior body capable of simultaneously solving the above plurality of issues.

In response to the above issues, an object of the present invention is to provide an exterior body capable of improving the energy density of a battery cell, suppressing permeation of moisture into the interior of the battery cell, and achieving high thermal conductivity.
(1) A first aspect of the present invention relates to an exterior body for housing an electrode laminate. The exterior body includes a metal layer, an inner resin layer disposed on an inner side of the metal layer, and an outer resin layer disposed on an outer side of the metal layer. The inner resin layer includes a first layer including a cycloolefin polymer. The inner resin layer includes a facing part facing the electrode laminate in a laminating direction and a non-facing part not facing the electrode laminate. The facing part includes a region having a thickness in the laminating direction that is smaller than that of the non-facing part.

According to the first aspect of the invention, it is possible to provide an exterior body capable of improving the energy density of a battery cell, suppressing permeation of moisture into the interior of the battery cell, and achieving high thermal conductivity.
(2) In a second aspect of the invention according to the first aspect, the non-facing part includes a sealing part. The inner resin layer includes a second layer including a material different from that of the first layer in the sealing part.

According to the second aspect of the invention, since the insulating properties of the exterior body can be ensured reliably and the sealing strength can be ensured stably, it contributes to improvement of gas barrier properties.
(3) In a third aspect of the invention according to the first or second aspect, the metal layer has a thickness greater than or equal to a predetermined thickness.

According to the third aspect of the invention, the thermal conductivity of the exterior body can be improved.
(4) In a fourth aspect of the invention according to any one of the first to third aspects, at least a part of a second layer is removed in a region comprising at least the facing part.

According to the fourth aspect of the invention, it is possible to provide an exterior body capable of improving the energy density of the battery cell.
(5) A fifth aspect of the invention provides a battery module including a plurality of battery cells stacked, each including the electrode laminate housed in the exterior body according to any one of the first to fourth aspects. A buffer material is disposed between the plurality of battery cells.

According to the fifth aspect of the invention, since the thickness in the laminating direction of the battery cell including the exterior body of the present invention can be reduced, the thickness of the buffer material of the battery module can be increased correspondingly, and the durability of the battery module and the ability to absorb expansion and contraction of the battery cells can be improved while the overall thickness of the battery module is made equal to or less than that of conventional ones. Alternatively, the rigidity and durability of the battery module can be further improved even when the overall thickness of the battery module increases as compared with conventional art.
(6) A sixth aspect of the invention provides a method for manufacturing a battery cell including the electrode laminate housed in the exterior body according to any one of the first to fourth aspects. The exterior body includes a sealing part in the non-facing part. The method includes sealing the sealing part by welding at a temperature equal to or higher than a melting point or a melting temperature of a resin constituting the inner resin layer.

According to the sixth aspect of the invention, since the sealing strength can be stably ensured, the thickness of the second layer can be reduced, which contributes to improvement of the gas barrier properties of the exterior body.

### BRIEF DESCRIPTION OF THE DRAWINGS

FIG. 1 is a perspective view of a battery cell according to the present embodiment;

FIG. 2 is a sectional view showing the layer structure of a sealing part of an exterior body according to the present embodiment; and

FIG. 3 is a sectional view showing the layer structure of a facing part of the exterior body according to the present embodiment.

### DETAILED DESCRIPTION OF THE INVENTION

An embodiment of the present invention will now be described with reference to the drawings. The present invention is not limited to the following embodiment.

### <Overall Configuration of Battery Cell>

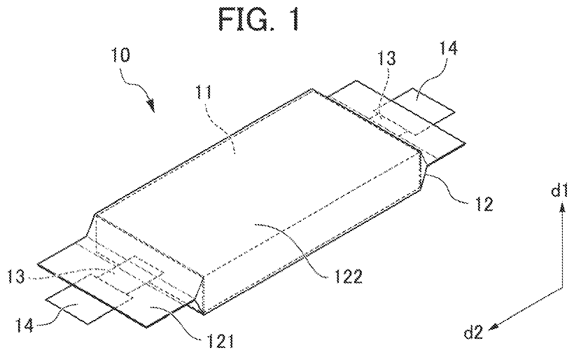

As shown in FIG. 1, a battery cell 10 according to the present embodiment includes an electrode laminate 11 and an exterior body 12 for housing the electrode laminate 11. The electrode laminate 11 includes a positive electrode layer, an electrolyte, and a negative electrode layer. The positive electrode layer and the negative electrode layer each include an electrode current collector, and a pair of current collecting tabs 13 respectively connected to the electrode current collectors extend from both end surfaces of the electrode laminate 11. The current collecting tab 13 is connected to a current collecting tab lead 14. At least a part of the current collecting tab lead 14 extends from the exterior body 12. With the above configuration, electricity can be drawn via the current collecting tab lead 14.

The battery cell 10 may include an electrolytic solution in which an electrolyte is dissolved in a solvent as an electrolyte, or may include a solid electrolyte as an electrolyte. The solid electrolyte includes the concept of a gel-like semi-solid electrolyte. The type of the battery cell 10 is not limited, and examples thereof include a lithium ion secondary battery and a lithium metal battery.

The electrode laminate 11 is formed by laminating at least a positive electrode layer and a negative electrode layer. When the battery cell 10 includes an electrolytic solution, a separator and an electrolytic solution are disposed between the positive electrode layer and the negative electrode layer. When the battery cell 10 includes a solid electrolyte, a sheet-shaped solid electrolyte is laminated between the positive electrode layer and the negative electrode layer. In FIG. 1, the laminating direction in which at least the positive electrode layer and the negative electrode layer are laminated is denoted by d1. The extending direction in which the current collecting tab lead 14 extends from the exterior body 12 is denoted by d2. The extending direction d2 is orthogonal to the laminating direction d1.

The positive electrode layer includes a positive electrode active material and a positive electrode current collector. For example, the positive electrode layer is formed by coating a positive electrode material mixture containing a positive electrode active material on a positive electrode current collector having a foil shape, a plate shape, or the like. The positive electrode active material and the positive electrode current collector are not limited, and materials known as positive electrode active materials and positive electrode current collectors for secondary batteries can be applied.

Examples of the positive electrode active material include transition metal chalcogenides such as titanium disulfide, molybdenum disulfide, and niobium selenide; and transition metal oxides such as lithium nickelate (LiNiO₂), lithium manganate (LiMnO₂, LiMn₂O₄), and lithium cobaltate (LiCoO₂). Examples of the positive electrode current collector include aluminum, aluminum alloys, stainless steel, nickel, iron, and titanium. The positive electrode material mixture may contain a solid electrolyte, a conductivity aid, a binder, and the like, in addition to the positive electrode active material.

The negative electrode layer includes a negative electrode active material and a negative electrode current collector. For example, the negative electrode layer is formed by coating a negative electrode material mixture containing a negative electrode active material on a negative electrode current collector having a foil shape, a plate shape, or the like. Alternatively, the negative electrode current collector and the foil-shaped or plate-shaped negative electrode active material may be joined by a cladding material or the like. The negative electrode active material and the negative electrode current collector are not limited, and materials known as negative electrode active materials and negative electrode current collectors for secondary batteries can be applied.

Examples of the negative electrode active material include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metallic indium. When the battery cell 10 is a lithium metal battery, examples of the negative electrode active material include lithium metal, lithium alloys such as Li—Al alloys and Li—In alloys, lithium titanate such as Li₄Ti₅O₁₂, and carbon materials such as carbon fiber and graphite. Examples of the negative electrode current collector include nickel, copper, and stainless steel. In addition to the negative electrode active material, the negative electrode material mixture may contain a solid electrolyte, a conductivity aid, a binder, and the like.

The electrolyte is not limited, and materials known as electrolytes for secondary batteries can be applied. When the electrolyte is an electrolytic solution, for example, the electrolytic solution can be obtained by dissolving a lithium salt such as LiPF₆, LiFSI, LiTFSI, LiBOB, LiDFP, or LiDFOB in a solvent such as ethylene carbonate (EC), propylene carbonate (PC), dimethyl carbonate (DMC), ethyl methyl carbonate (EMC), diethyl carbonate (DEC), or γ-butyrolactone (γBL). As the separator, known members used in secondary batteries can be applied. When the electrolyte is a solid electrolyte, examples of the solid electrolyte include sulfide-based solid electrolyte materials, oxide-based solid electrolyte materials, nitride-based solid electrolyte materials, and halide-based solid electrolyte materials.

### <Exterior Body>

By housing the electrode laminate 11, the exterior body 12 suppresses entry of oxygen and moisture into the electrode laminate 11. The exterior body 12 includes a facing part 122 that is a region facing the electrode laminate 11 in the laminating direction d1, and a non-facing part 121 that is a region not facing the electrode laminate 11. The exterior body 12 includes a metal layer, an inner resin layer disposed on an inner side of the metal layer, and an outer resin layer disposed on an outer side of the metal layer. Such an exterior body 12 is in the form of one or more films, and the electrode laminate 11 is housed within the exterior body 12 by overlapping and welding the films together at the sealing part in the non-facing part 121.

### (Non-Facing Part)

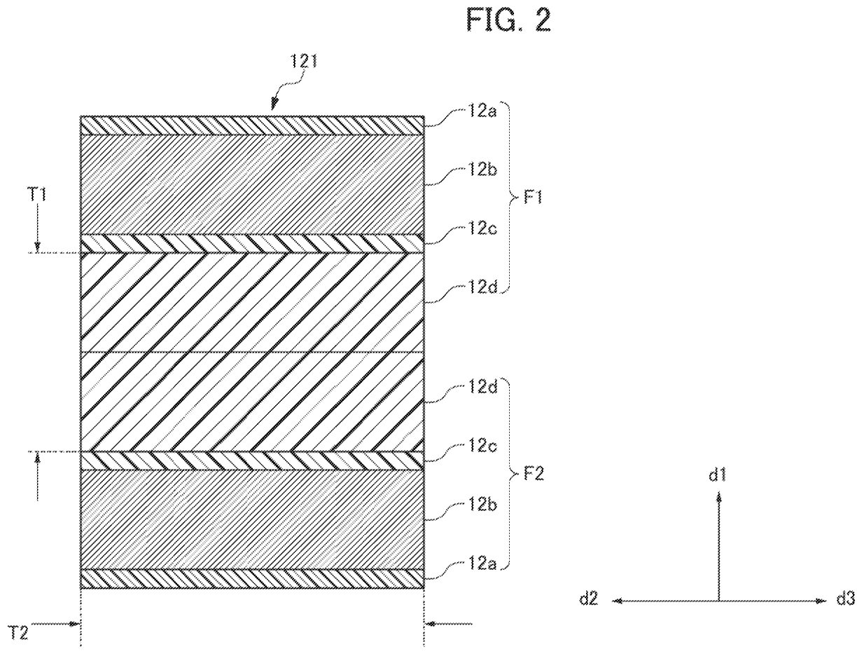

As shown in FIG. 2, the exterior body 12 in the non-facing part 121 includes outer resin layers 12a, metal layers 12b, and inner resin layers 12c and 12d. FIG. 2 is a sectional view of the sealing part in the non-facing part 121 taken along the laminating direction d1, schematically showing a state in which two films F1 and F2 are arranged such that the inner resin layers 12d are in contact with each other and welded. In subsequent descriptions, the inner resin layer 12c may be referred to as a first layer 12c, and the inner resin layer 12d may be referred to as a second layer 12d. As shown in FIG. 2, the first layer 12c is disposed between the metal layer 12b and the second layer 12d, and the second layer 12d is disposed on the innermost side of the exterior body 12.

The outer resin layer 12a is disposed on the outermost side of the exterior body 12. The outer resin layer 12a preferably includes a material excellent in chemical resistance, moldability, scratch resistance, insulating properties, and the like. Examples of the resin constituting the outer resin layer 12a include polyamide resin such as nylon, polyester resin, polyethylene terephthalate resin, and polybutylene terephthalate resin. Among them, polyamide resin is preferable. The outer resin layer 12a may include a single resin or include a combination of a plurality of resins. The thickness of the outer resin layer 12a is not limited, and may be, for example, about 15 μm.

The metal layer 12b provides the exterior body 12 with gas barrier properties to suppress entry of oxygen and moisture. The metal layer 12b preferably has a certain rigidity. Examples of the metal layer 12b include aluminum foil, copper foil, and stainless steel foil. The metal layer 12b preferably has a thickness equal to or greater than a predetermined thickness because high thermal conductivity can be provided to the exterior body 12. The thickness of the metal layer 12b may be, for example, greater than 40 μm. Although the thickness of the metal layer of the exterior body of a commonly used battery cell is about 40 μm, by setting the thickness of the metal layer 12b to, for example, 80 μm, a temperature reduction effect of about 3° C. to 10° C. can be obtained when the battery cell 10 is rapidly charged. In view of the above, the thickness of the metal layer 12b may be 80 μm or more.

The first layer 12c contains a cycloolefin polymer (COP). Since the first layer 12c contains a cycloolefin polymer (COP), it has insulating properties and a very low moisture permeability. The melting point or melting temperature of the resin constituting the first layer 12c is higher than the melting point or melting temperature of the resin constituting the second layer 12d. The thickness of the first layer 12c may be 12 μm or less, for example.

The first layer 12c preferably contains 50% by mass or more of cycloolefin polymer (COP) as a main component. As the cycloolefin polymer (COP), a known substance obtained by polymerizing or copolymerizing a cyclic olefin can be used. The first layer 12c may contain other substances in addition to the cycloolefin polymer (COP). For example, a cycloolefin copolymer obtained by addition polymerization of monomers other than cyclic olefins may be contained.

By disposing the first layer 12c between the metal layer 12b and the second layer 12d, even when the sealing part is sealed at a high temperature and a high load, the two metal layers 12b can be prevented from contacting each other. Therefore, the insulating properties of the exterior body 12 can be ensured reliably. By sealing the sealing part at a high temperature and a high load, the sealing strength can be stably ensured, so that the thickness of the second layer 12d described later can be reduced. This contributes to improvement of gas barrier properties.

The second layer 12d provides the exterior body 12 with thermal fusion bonding properties. In addition to the above, the second layer 12d preferably has chemical resistance and an effect of suppressing moisture permeation. The resin constituting the second layer 12d is a thermoplastic resin having thermal fusion bonding properties, and examples thereof include polypropylene, polyethylene, and an olefin-based copolymer. The second layer 12d may include one of the above resins or a combination of a plurality of the above resins.

The thickness of the second layer 12d is not limited, but may be, for example, 30 to 100 μm. By setting the thickness of the second layer 12d to be equal to or greater than a predetermined thickness, a preferable thermal fusion bonding strength can be obtained. Furthermore, by setting the thickness of the second layer 12d to be equal to or less than a predetermined thickness, entry of oxygen or moisture can be suppressed. That is, moisture permeation can be suppressed and the gas barrier properties can be improved. This point will be described below.

In FIG. 2, a direction opposed to the extending direction d2 is shown as a cell interior direction d3. The permeation of moisture and gas into the interior of the exterior body 12 is predominantly from the outside of the exterior body 12 in the non-facing part 121 to the cell interior direction d3. This is because in the non-facing part 121, there is a portion in which only the resin layer exists and the metal layer does not exist, on a straight line extending in the cell interior direction d3. Therefore, if the first layers 12c do not exist, the smaller the total thickness Ti of the second layers 12d in the non-facing part 121 is, the more the permeation of moisture and gas into the interior of the exterior body 12 is suppressed. Furthermore, the longer the sealing length T2 of the sealing part in the non-facing part 121 in the extending direction d2 and in the cell interior direction d3, permeation of moisture and gas into the interior of the exterior body 12 is suppressed.

In the sealing part in the non-facing part 121, the second layers 12d of the two films are brought into contact with each other, heated at a temperature higher than or equal to the melting point or melting temperature of the resin constituting the second layer 12d and lower than the melting point or melting temperature of the resin constituting the first layer 12c, and thermally fusion bonded, whereby the exterior body 12 can be sealed. Here, by disposing the first layer 12c having insulating properties between the metal layer 12b and the second layer 12d, the total thickness Ti of the second layers 12d can be made smaller without risk of short circuit during sealing. For example, it is possible to make Ti equal to a thickness of 20 to 50% of the thickness before sealing. This suppresses permeation of moisture and gas into the interior of the exterior body 12. Furthermore, since the first layer 12c has very low moisture permeability, moisture permeation into the interior of the exterior body 12 is suppressed.

### (Facing Part)

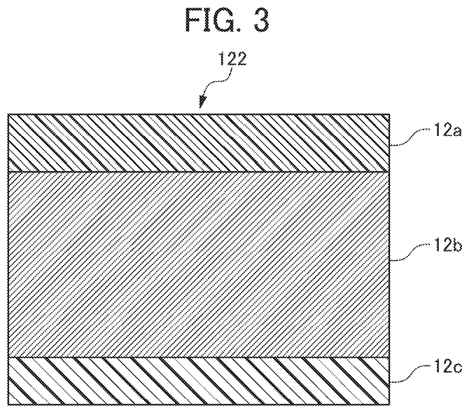

As shown in FIG. 3, the exterior body 12 in the facing part 122 includes the outer resin layer 12a, the metal layer 12b, and the first layer 12c that is an inner resin layer. FIG. 3 is a sectional view of the facing part 122 taken along the laminating direction d1. The details of the configuration of each layer are the same as those in the non-facing part 121. The facing part 122 includes a region having a thickness in the laminating direction that is smaller than that of the non-facing part. The facing part 122 preferably has a thickness in the laminating direction that is smaller than that of the non-facing part over all regions. This enables the thickness of the battery cell 10 in the laminating direction d1 to be reduced. Therefore, the amount of energy per volume of the battery cell 10 and a battery module formed by laminating a plurality of the battery cells 10 in the laminating direction d1 can be increased. Alternatively, instead of the above, by increasing the thickness of the buffer material disposed between the battery cells 10 of the battery module, which will be described later, it is possible to provide a configuration in which the amount of energy per volume is maintained and the expansion of the electrode laminate 11 during charging is easily followed.

For example, as shown in FIG. 3, the above configuration of the facing part 122 can be realized by configuring the facing part 122 not to include the second layer 12d, or configuring the thickness of the second layer 12d to be smaller than the thickness of the second layer 12d in the non-facing part 121. Even in the case of the above configuration, since the facing part 122 includes the first layer 12c having very low moisture permeability, the effect of suppressing moisture permeation of the exterior body 12 is ensured.

### <Battery Module>

A plurality of the battery cells 10 according to the present embodiment can be stacked to form a battery module. The configuration of the battery module is not limited, and configurations used for known battery modules can be applied. In particular, it is preferable to apply a configuration in which a buffer material is disposed between the plurality of battery cells 10. This is because the battery cell 10 according to the present embodiment can be made thin in the laminating direction, and therefore, by making the thickness of the buffer material thicker correspondingly, it is possible to easily follow the expansion of the battery cell 10 due to charging and discharging.

In addition to the above, the battery module according to the present embodiment may include a mounting plate for mounting the battery cell 10, a cooling plate for cooling the battery cell 10, a vibration-proofing material, a fixing film, and the like.

### [Method for Manufacturing Exterior Body]

The method for manufacturing the exterior body 12 including the non-facing part 121 and the facing part 122 is not limited. For example, the exterior body 12 can be manufactured by bonding the outer resin layer 12a, the metal layer 12b, the first layer 12c, and the second layer 12d together by a known method to obtain a film in which these layers are laminated in this order, cutting or forming the film into a predetermined size, and then removing a part or all of the second layer 12d in at least a region facing the electrode laminate 11 in the laminating direction d1.

### [Method for Manufacturing Battery Cell]

The method for manufacturing the battery cell 10 according to the present embodiment includes a housing step of housing the electrode laminate 11 in the exterior body 12, and a sealing step of sealing the sealing part of the exterior body 12 by welding.

The housing step is a step of housing the electrode laminate 11 in the exterior body 12.

The sealing step is a step of sealing the sealing part by bringing the two second layers 12d in the sealing part of the exterior body 12 into contact with each other and welding them at a temperature equal to or higher than the melting point or melting temperature of the resin constituting the inner resin layer. By setting the temperature in the sealing step to the above range, the sealing strength can be stably ensured, and therefore the thickness of the second layer 12d can be reduced. This contributes to improvement of the gas barrier properties of the exterior body 12. The temperature at the time of welding in the sealing step is preferably 200° C. or higher, and the upper limit thereof is preferably lower than the melting temperature of the cycloolefin polymer (COP).

Although a preferred embodiment of the present invention has been described above, the present invention is not limited to the above embodiment and can be modified as appropriate.

### EXPLANATION OF REFERENCE NUMERALS

11 electrode laminate
12 exterior body
12a outer resin layer
12b metal layer
12c first layer
12d second layer
121 non-facing part
122 facing part

What is claimed is:

1. An exterior body for housing an electrode laminate, the exterior body comprising:
a metal layer; an inner resin layer disposed on an inner side of the metal layer; and an outer resin layer disposed on an outer side of the metal layer,
the inner resin layer comprising a first layer comprising a cycloolefin polymer, and
the inner resin layer comprising a facing part facing the electrode laminate in a laminating direction and a non-facing part not facing the electrode laminate, the facing part comprising a region having a thickness in the laminating direction that is smaller than that of the non-facing part.

2. The exterior body according to claim 1,
wherein the non-facing part comprises a sealing part, and
wherein the inner resin layer comprises a second layer comprising a material different from that of the first layer in the sealing part.

3. The exterior body according to claim 1, wherein the metal layer has a thickness greater than or equal to a predetermined thickness.

4. The exterior body according to claim 2, wherein at least a part of the second layer is removed in a region comprising at least the facing part.

5. A battery module comprising a plurality of battery cells stacked, each comprising the electrode laminate housed in the exterior body according to claim 1,
wherein a buffer material is disposed between the plurality of battery cells.

6. A method for manufacturing a battery cell comprising the electrode laminate housed in the exterior body according to claim 1,
the exterior body comprising a sealing part in the non-facing part, and
the method comprising sealing the sealing part by welding at a temperature equal to or higher than a melting point or a melting temperature of a resin constituting the inner resin layer.
